(19) United States
(12) Patent Application Publication
(10) Pub. No.: US 2012/0068379 A1
(43) Pub. Date: Mar. 22, 2012

(54) REUSABLE EAR FITTING PIECE FOR CREATING AN EAR IMPRESSION

(75) Inventors: Harald Klemenz, Fuerth (DE); Benjamin Neumann, Nuernberg (DE)

(73) Assignee: SIEMENS MEDICAL INSTRUMENTS PTE. LTD., Singapore (SG)

(21) Appl. No.: 13/322,956

(22) PCT Filed: May 25, 2010
(86) PCT No.: PCT/EP2010/057168

§ 371 Date: Nov. 29, 2011

(30) Foreign Application Priority Data
May 29, 2009 (DE) 10 2009 023 302.4

(51) Int. Cl. B29C 51/42; B28B 7/30

(52) U.S. Cl. 264/313; 249/55

(57) ABSTRACT

An ear fitting piece for creating an ear impression and a method for creating an ear impression. In order to allow the creation of an ear impression at low cost, the ear fitting piece for creating an ear impression has a liquid, which has a first state in which it can be shaped and a second state in which it is solidified, a soft rubber sleeve, which encloses the liquid, and an activating device, which is designed to cause a change of state from the first state to the second state of the liquid. A further change of state from the second state to the first state of the liquid can be caused by heating.

The invention relates to an ear fitting piece for creating an ear impression, as well as a method for creating an ear impression.

Such an ear fitting piece is used to map the contour of an ear and, in the case of hearing devices in particular the contour of an auditory canal of a patient, so that the ear fitting piece represents a negative mold of an ear section to be mapped. This negative mold can now be used to create a personalized hearing device. The hearing device here is tailored to the shape of the auditory canal of a patient, to ensure that it is comfortable to wear and the transmission quality is optimal. The ear fitting piece serves as a reference for this. With the ear fitting piece it is possible to personalize and therefore improve both in-the-ear hearing devices and behind-the-ear hearing devices.

The personalized ear fitting piece is generally created using a soft plastic material, which is introduced into an auditory canal of an ear of a patient. When the plastic material has hardened in the ear, the plastic mass is removed from the ear. The plastic mass now has an outer contour, which corresponds to the inner contour of the corresponding auditory canal of the patient. This negative mold can now be used to produce a personalized hearing device with the aid of known means.

An ear insert for hearing devices is known from DE 88 16 266 U1, featuring a mold element to be tailored to the auditory canal of the user, which is made of an initially viscous, then hardenable material, enclosed in a protective sleeve.

Vehicle upholstery is described in DE 102 27 131 A1, the shape of which can be changed by changing the aggregate state of a liquid.

DE 10 2005 009 348 A1 relates to a solidifiable material, for example a thermoplastic, a duroplastic, a synthetic foam or a crystallizable liquid, serving as a filler mass for molding.

The object of the present invention is to allow the creation of an ear impression in an economical manner.

According to the invention this object is achieved by the apparatus as claimed in claim 1, i.e. by an ear fitting piece for creating an ear impression, comprising:
a liquid, which has a first state in which it can be shaped, and a second state in which it is solidified,
a soft rubber sleeve, which encloses the liquid, and
an activating means, which is configured to bring about a change of state from the first state to the second state of the liquid,

wherein a further change of state can be brought about from the second state to the first state of the liquid by heating.

The object is also achieved by a method for creating an ear impression, consisting of the following steps:
introducing an ear fitting piece, as claimed in one of the preceding claims, into an auditory canal of a person,
activating the activating means to bring about the change of state,
removing the ear fitting piece from the auditory canal of the person, the ear fitting piece now featuring the ear impression of said person,
heating the ear fitting piece to bring about the further change of state, so that the liquid can be shaped once again.

Advantageous developments of the invention are defined in the respective dependent claims.

In the first state the ear fitting piece should have the property that it can be inserted easily into an auditory canal of an ear of a patient. This can be controlled by the selection of the soft rubber sleeve and the liquid. The soft rubber sleeve here should have the property that the liquid is securely enclosed and should have mechanical stability such that the soft rubber sleeve is not damaged by insertion into the auditory canal and the change of state that takes place. As soon as the ear fitting piece fills the necessary region of the auditory canal of the patient, the activating means can be used to bring about a change of state of the liquid. The state of the liquid here changes so that a solidified state of the liquid results from the moldable state. The ear fitting piece now has a negative shape of the filled region, thus forming the ear impression. Once the liquid is in the second state, the ear fitting piece can be removed from the auditory canal of the patient. The solidified state of the liquid here should have such rigidity that the ear fitting piece can be removed from the auditory canal of the patient and still have the negative shape assumed after the change of state. This provides the personalized ear impression of the patient.

This ear impression can be used for example to create a patient-specific hearing device. The personalized ear impression is “read in”, for example using an optical measuring system, in which the geometric shape of the ear impression is read into a system. This data can then be used for further processing as desired.

The disadvantage of a conventional ear fitting piece is that the finished ear fitting piece cannot be reused to create a new ear impression, as its shaping and solidification are irreversible.

Because heating the liquid in the inventive ear fitting piece brings about a further change of state of the liquid, specifically a “return” to the first state, it is possible to reuse the inventive ear fitting piece to create a new ear impression. Therefore the same ear fitting piece can be used to create a number of ear impressions. This has the advantage that a single-use item is replaced by a reusable item and the user only has a one-off purchase cost. A further advantage is that if a first attempt to create the ear impression fails, the process can be repeated as often as necessary with the same ear fitting piece. Since the ear fitting piece can be reused, the patient for whom an ear impression is being created incurs fewer costs. Also less waste is created.

In one advantageous embodiment of the invention the activating means makes contact with the liquid.

Since the activating means is in direct contact with the liquid, a fast pulse emission can take place, to bring about the change of state.

In a further advantageous embodiment of the invention the change of state of the liquid is a phase transition from liquid to solid and the further change of state of the liquid is a phase transition from solid to liquid.

Because the change of state is a phase transition from liquid to solid, it can be ensured that the ear fitting piece has the necessary mechanical stability required during subsequent further processing. The further change of state of the liquid, in which the phase transition from solid to liquid takes place, ensures that the ear fitting piece has the necessary moldability and elasticity required to create a new ear impression.

In a further advantageous embodiment of the invention the liquid is formed by a latent heat storage material, in particular with a salt or paraffin base.

This has the advantage that the further change of state of such liquids is in a range outside normal ambient temperature. This allows the ear fitting piece to be brought easily to the second state and to harden in this state. Conversion to the first state only takes place when the further change of state is brought about by heating. Since with such materials the further change of state can be set so that it is outside normal ambient temperature, the process can be controlled specifically. An inadvertent change in the liquid from the second state to the first state can thus be avoided. Also it means that there is no urgency to measure the ear fitting piece once the second state has been brought about.

In a further advantageous embodiment of the invention the activating means is configured to generate a pressure wave in the liquid.

It is possible to bring about the change of state from the first state to the second state, in particular by means of a pressure wave in the liquid, such as for example a latent heat storage material. A pressure wave can be brought about for example by a small metal sheet located in the liquid.

In a further advantageous embodiment of the invention the activating means comprises a piezo element.

The piezo effect can be utilized in that an electric voltage applied to the activating means causes the activating means to perform a mechanical movement. The mechanical movement here is intended to generate a pressure wave in the liquid. A crystallization process is hereby initiated, bringing about the change of state, particularly if the liquid is formed by a latent heat storage material. An electric voltage can likewise initiate the crystallization process so that the activating means utilizes the piezo effect in that when the user generates a mechanical movement at the activating means, an electric voltage is produced at the liquid, which ultimately brings about the change of state.

In a further embodiment of the invention, after being brought about by the activating means, the second state of the liquid is permanent until the further change of state.

This ensures that the ear fitting piece can be removed from the auditory canal of a patient without mechanical damage and has the necessary stability for subsequent measuring.

In a further advantageous embodiment of the invention the liquid is configured so that the change of state takes place within 15 seconds.

This has the advantage that the process of activating the ear fitting piece introduced into the auditory canal of the patient until the second state of the liquid is reached is within a manageable time frame for patient and user.

In a further advantageous embodiment of the invention the activating means is configured and dimensioned so that it can be gripped and activated using the fingers when the ear fitting piece is introduced into an auditory canal of a person.

This makes it easy for the user to activate the change of state and remove the ear fitting piece once the liquid has solidified. Also the ear fitting piece can be held or fastened for example for further processing at this point, without the risk of the negative mold of the auditory canal, formed by the soft rubber sleeve and the solidified liquid contained therein, being mechanically destroyed.

In a further advantageous embodiment of the invention the ear fitting piece is configured so that it essentially maintains its volume during the change of state.

This ensures that an ear impression is created which is true to the original so there is no distortion of the ear to be measured.

The invention and embodiments of the invention are described and explained in more detail below with reference to the exemplary embodiments illustrated in the figures, in which:

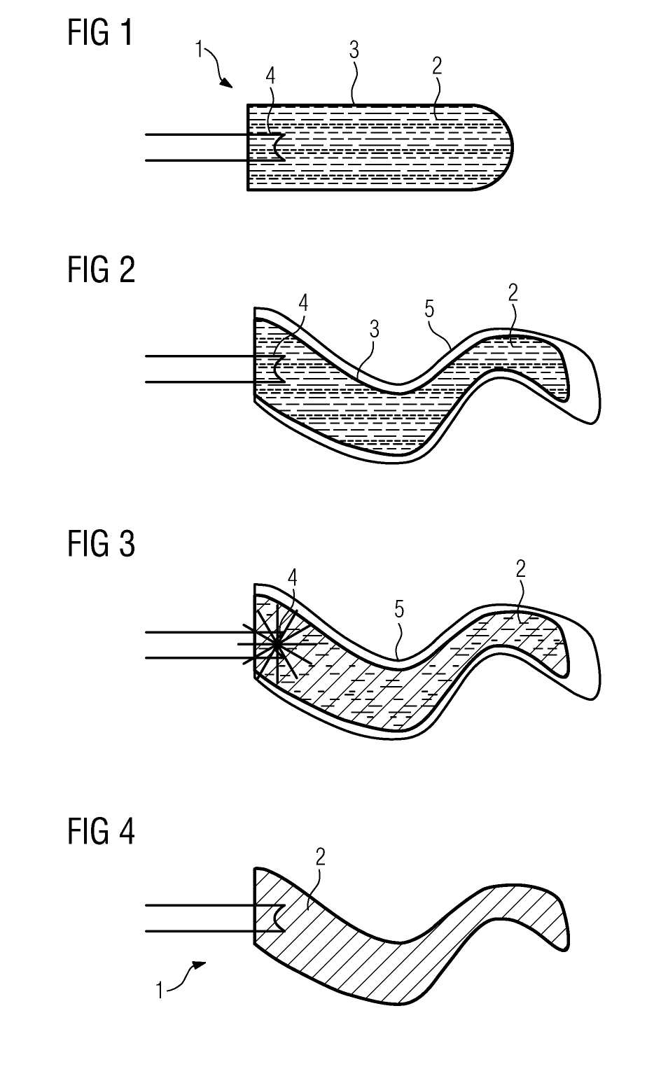

FIG. 1 shows a schematic structure of an ear fitting piece,

FIG. 2 shows the ear fitting piece from FIG. 1 introduced into an auditory canal,

FIG. 3 shows the ear fitting piece illustrated in FIG. 2, with the activating means having brought about a change of state of the liquid,

FIG. 4 shows the ear fitting piece illustrated in FIG. 3, after removal from the auditory canal.

FIG. 1 shows a schematic structure of an ear fitting piece 1. This ear fitting piece 1 has a soft rubber sleeve 3, which encloses the liquid 2. An activating means 4 projects into the soft rubber sleeve 3. The liquid 2 of the ear fitting piece 1 is currently in a first state. The liquid 2 is a latent heat storage material, for example sodium acetate. The liquid 2 can also have a paraffin base. A change of state of the liquid 2 can be brought about by the activating means 4. Such a change of state causes the liquid 2 to change from a first state to a second state, in which the liquid 2, and therefore the ear fitting piece 1, has solidified and is mechanically stable. In the first state the liquid 2, and therefore the ear fitting piece 1, can be shaped so that the soft rubber sleeve 3 enclosing the liquid 2 can be introduced easily into an auditory canal of a person. A major advantage of the ear fitting piece 1 is that it can be reused. When the liquid 2 is in the second state, a further change of state can be brought about by heating. Heating restores the first state of the liquid 2. The activating means 4 can now be used again to bring about a change of state from the first state to the second state of the liquid 2. This process between the change of state and the further change of state can be repeated as often as required. For the activating means 4 to bring about a change of state of the liquid 2, the activating means 4 must generate a pressure wave in the liquid 2. The activating means 4 generates a pressure wave for example by means of a small metal plate or piezo element present in the liquid 2. In the case of sodium acetate the pressure wave causes a crystallization process. A phase transition takes place from liquid to solid. Since heat is produced during this process, the soft rubber sleeve is embodied so that the heat transfer is delayed. If the further change of state of the liquid from solid to liquid is then to be brought about, the sodium acetate or the ear fitting piece 1 simply has to be heated in a water bath or using a hair-dryer so that melting point is exceeded. Hard paraffin has a melting point of around 60° C. for example, at which a phase change takes place again from solid to liquid.

FIG. 2 shows the ear fitting piece from FIG. 1 introduced into an auditory canal 5. It can be seen here that the ear fitting piece adjusts to the shape of the auditory canal. 5. Because a soft rubber sleeve 3 is used to enclose the liquid 2, introduction into the auditory canal 5 can be effected easily. The activating means 4 is located partly in the liquid 2 and likewise projects out of the auditory canal 5. On the one hand this allows easy introduction of the ear fitting piece 1 into the auditory canal 5 and on the other hand it allows the user to operate and activate the change of state easily.

FIG. 3 shows the ear fitting piece illustrated in FIG. 2, with the activating means 4 having brought about a change of state of the liquid 2. It can be seen that the liquid 2 has solidified. The ear fitting piece now forms a negative mold of the auditory canal 5. It should be noted here that the liquid 2 essentially maintains its volume through the change of state, so that the negative shape of the auditory canal 5 is mapped. The ear fitting piece 1 should remain in the auditory canal until the liquid has solidified so that no permanent mechanical deformation of the solidified ear fitting piece is produced when it is removed.

FIG. 4 shows the ear fitting piece illustrated in FIG. 3, after removal from the auditory canal 5. It can be seen that the ear fitting piece forms a negative mold of the auditory canal. This ear impression can be used to configure a personalized hearing device. Known methods can be used to determine the dimensions of the ear impression and thus of the auditory canal of the patient. Once this data has been captured, the ear fitting mold 1 can be reused. For this it simply has to be heated to above the boiling point of the liquid 2 using a water bath or hair-dryer for example, so that a phase change of the liquid 2 from solid to liquid takes place and the ear fitting piece 1 again has the moldability required for introduction into an auditory canal. In the case of sodium acetate boiling point is around 60° C. The ear fitting piece 1 therefore allows a number of different ear impressions to be created. A user therefore has a reusable ear fitting piece 1 for creating an ear impression. Material costs can be minimized, the environmental burden can be reduced and the reusable nature of the ear fitting piece 1 means that costs can be reduced for the provider and user.

1-11. (canceled)

12. An ear fitting piece for creating an ear impression, comprising:
a liquid having a first state, in which the liquid can be shaped, and a second state, in which the liquid is solidified;
a soft rubber sleeve encasing the liquid;
an activating device configured to bring about a first change of state of the liquid from the first state to the second state; and
wherein a second change of state of the liquid can be brought about from the second state to the first state by heating.

13. The ear fitting piece according to claim 12, wherein said activating device is disposed to make contact with the liquid.

14. The ear fitting piece according to claim 12, wherein the first change of state of the liquid is a phase transition from liquid to solid and the second change of state of the liquid is a phase transition from solid to liquid.

15. The ear fitting piece according to claim 12, wherein the liquid is a latent heat storage material.

16. The ear fitting piece according to claim 15, wherein the liquid is a salt or paraffin base.

17. The ear fitting piece according to claim 12, wherein said activating device is configured to generate a pressure wave in the liquid.

18. The ear fitting piece according to claim 12, wherein said activating device comprises a piezo element.

19. The ear fitting piece according to claim 12, wherein after being brought about by said activating device, the second state of the liquid is permanent until the second change of state is initiated.

20. The ear fitting piece according to claim 12, wherein the liquid is configured so that the first change of state takes place within 15 seconds.

21. The ear fitting piece according to claim 12, wherein the activating device is configured and dimensioned so that it can be gripped and activated using the fingers when the ear fitting piece is introduced into an auditory canal of a person.

22. The ear fitting piece according to claim 12, wherein the ear fitting piece is configured to substantially maintain its volume during the first change of state.

23. A method for creating an ear impression, the method which comprises the following steps:
introducing an ear fitting piece according to claim 12 into an auditory canal of a person;
activating the activating device in order to bring about the first change of state;
removing the ear fitting piece from the auditory canal of the person, the ear fitting piece now featuring the ear impression of the person; and
heating the ear fitting piece to bring about the second change of state, so that the liquid may be shaped once more.
